(19) United States
(12) Patent Application Publication
(10) Pub. No.: US 2007/0170107 A1
(43) Pub. Date: Jul. 26, 2007

(54) Single body fuIl flow acid-neutralizing fluid filter

(76) Inventor: Zafar Hussain, Perrysburg, OH (US)

Correspondence Address: Honeywell International Inc.;Patent Legal Services, 101 Columbia Road, P. O. Box 2245, Morristown, NJ, 07962-2245, US

(21) Appl. No.: 11/488,466

(22) Filed: Jul. 18, 2006

Related U.S. Application Data
(60) Provisional application No. 60/700,227, filed on Jul. 18, 2005.

(51) Int. Cl. B01D 29/00

(52) U.S. Cl. 210/335; 210/314; 210/446; 210/450

(57) ABSTRACT

An oil filter for rejuvenating lubricating oil to prevent premature wear by ensuring that impurities will not circulate through the engine has a housing, a mechanically active filter element, and a chemically active filter element. A flow path defined by the housing is configured to pass the fluid entering the housing through housing inlets first through the chemically active filter element, then through a channel defined within the flow path of the housing at least partially disposed in a space separating the chemically active filter element and the mechanically active filter element, then through the mechanically active filter element, and finally to the housing outlets through which decontaminated and purified oil passes to the engine. In one exemplary embodiment of the present invention, substantially all of the fluid flowing through the housing passes through the chemically active filter element.

### CROSS REFERENCE TO RELATED APPLICATIONS

This application claims the benefit of United States Provisional Patent Application No. 60/700,227 filed Jul. 18, 2005 the contents of which are incorporated herein by reference thereto.

### TECHNICAL FIELD

This application relates to a fluid filter assembly for use in conjunction with an internal combustion engine, and more specifically to such an assembly with a single housing having both a mechanically active filter element and a chemically active filter element incorporated therein.

### BACKGROUND

In modem automobiles, many types of fluid filters are common. An oil filter is a fluid filter used to strain the oil in the engine thus removing abrasive particles. Most such filters use a mechanical or ‘screening’ type of filtration, with a replaceable cartridge having a porous filter element therein, through which oil is repeatedly cycled to remove impurities such as small particles or dirt and metal. “Dirty” oil enters an oil filter under pressure, passes through the filter media where it is “cleaned,” and then is redistributed throughout the engine. This can prevent premature wear by ensuring that impurities will not circulate through the engine and reach the close fitting engine parts. Filtering also increases the usable life of the oil.

It is common for the normal operation of an internal combustion engine, particularly that of a diesel engine, to result in the formation of contaminants. These contaminants include, among others, soot, which is formed from incomplete combustion of the fossil fuel, and acids that result from combustion. Both of these contaminants are typically introduced into the lubricating oil during engine operation and tend to increase oil viscosity and generate unwanted engine deposits, leading to increased engine wear.

The conventional solution to these problems has been to place various additives into lubricating oils, during their initial formulation. In order to combat soot-related problems, many conventional lubricating oils include dispersants that resist agglomeration of soot therein. These work well for a short period, but may become depleted. Additionally, due to the solubility and chemical stability limits of these dispersants in the oil, the service lives of the lubricating oil and the oil filter are less than optimal.

In order to counteract the effects of acidic combustion products, many conventional motor oils include neutralizing additives known as over-based detergents. These are a source of TBN (total base number), which is a measure of the quantity of the over-based detergent in the oil, expressed in terms of the equivalent number of milligrams of potassium hydroxide that is required to neutralize all basic constituents present in 1 gram of sample. Higher TBN oils provide longer lasting acid neutralization. The depletion of TBN is an important limiting factor for many internal combustion engines, and in particular for heavy-duty applications with diesel engines.

In order to improve engine protection and to combat other problems, conventional lubricating oils often include one or more further additives, which may be corrosion inhibitors, antioxidants, friction modifiers, pour point depressants, detergents, viscosity index improvers, anti-wear agents, and/or extreme pressure additives. The inclusion of these further additives may be beneficial; however, with conventional methods, the amount and concentration of these additives are limited by the ability of lubricating oils to suspend these additives, as well as by the chemical stability of these additives in the oil.

In addition to trapping impurities and decontaminating oil, it is the role of the oil filter to ensure fast and efficient flow through its media. Oil is the life blood of an engine, and its constant flow is essential for proper lubrication of engine components and the prevention of friction, heat and wear. Engine components rely on the oil circulation system to deliver a steady and adequate supply of motor oil.

Oil filters are typically housed in a canister that is held to the engine using a “spin-on” configuration. Some multiple stage oil filter housing designs that have multiple filter elements arranged concentrically in series are available. These filter designs, however, suffer from limited flow distribution (i.e. less channeling) that is provided by conventional single filter housings. Space within engine systems and other equipment is limited, and it is important that a filtration system be efficiently designed with respect to fast and efficient flow and the amount of space that is taken up.

Fluid filters are classified as either full-flow or bypass- or partial-flow systems. In the full-flow type of filter, all the fluid that enters the unit passes through a filtering element, while in the partial-flow type, only a portion of the fluid passes through the element. In a typical full-flow type oil filter, the oil flows into an inlet passage and then through the filtering element. After flowing through the filter element, the filtered, clean oil passes directly to the main oil gallery. Nevertheless, full-flow and bypass fluid filters have the drawback of not being able to chemically treat substantially all of the oil that passes into and flows through the fluid filters.

Accordingly, it is desirable to provide a full-flow filter having multiple stages contained within a filter housing, wherein one stage is a chemically active filter element, the other is a mechanically active filter element, through which substantially all oil passing through the filter is able to pass completely through the chemically active filter element, and having a flow path employing a flow channel that facilitates a flow distribution that is adequate to allow the filter to deliver a steady and adequate supply of decontaminated and purified oil to the engine.

### SUMMARY

Disclosed herein is an oil filter that comprises a housing, a mechanically active filter element, and a chemically active filter element. A flow path defined by the housing is configured to pass the fluid entering the housing through housing inlets first through the chemically active filter element, then through a channel defined within the flow path at least partially located in a space separating the chemically active filter element and the mechanically active filter element, then through the mechanically active filter element, and finally to the housing outlets through which decontaminated and purified oil passes to the engine. In one exemplary embodiment of the present invention, substantially all of the fluid flowing through the housing passes through the chemically active filter element.

Accordingly, exemplary embodiments of the present invention are directed to a multiple stage filter that is able to both filter impurities and counteract the effects of acidic combustion products in oil by providing a full-flow filtration system that is able to pass used oil entering the filter through both a chemically active filter element and a mechanically active filter element sequentially, wherein substantially all of the oil entering the system passes through the chemically active filter element; and providing, for such a filtration system, a flow path design which facilitates a flow distribution that does not limit fluid flow through the chemically active filter element.

An oil filter, comprising: a housing having an inlet and an outlet and defining a fluid flow path between the inlet and outlet through a chamber therein; a filter element disposed inside the housing in the flow path, the filter element comprising a body of filter media having an exterior surface and an interior surface and a first end opening and a second end opening each providing access to an internal cavity of the filter element, wherein fluid is filtered by passing through the inlet, through the exterior surface into the cavity and through the outlet; a first end cap positioned about the first end opening, wherein the first end cap comprises a sealing ring of material disposed about the first opening and a second end cap positioned about the second end opening, wherein the second end cap comprises a sealing ring of material disposed about the second opening, the first end cap and the second end cap sealing the cavity into fluid communication with the outlet; and a chemically active filter element having inlet openings and outlet openings, the chemically active filter element being disposed inside the housing and configured to receive substantially all fluid flowing into the housing through the housing inlet.

An oil filter, comprising: a housing having an inlet and an outlet and defining a fluid flow path between the inlet and outlet through a chamber therein; a filter element disposed inside the housing in the flow path, the filter element comprising a body of filter media having an exterior surface and an interior surface and a first end opening and a second end opening each providing access to an internal cavity of the filter element, wherein fluid is filtered by passing through the inlet, through the exterior surface into the cavity and through the outlet; a first end cap positioned about the first end opening, wherein the first end cap comprises a sealing ring of material disposed about the first opening and a second end cap positioned about the second end opening, wherein the second end cap comprises a sealing ring of material disposed about the second opening, the first end cap and the second end cap sealing the cavity into fluid communication with the outlet; and a chemically active filter element having inlet openings and outlet openings, the chemically active filter element being disposed inside the housing and in a facing spaced relationship with respect to the first end cap to define a channel between the first end cap and the outlet openings, wherein the channel does not limit fluid flow through the chemically active filter element.

A method for rejuvenating lubricating oil by filtration, comprising: introducing a fluid to a filtering apparatus comprising a chemically active filter element and a filter element; filtering substantially all of the fluid introduced to the filtering apparatus with the chemically active filter element; passing chemically treated fluid into and through a channel defined between the chemically active filter element and the filter element, the channel being configured so as to not limit fluid flow through the chemically active filter element; and filtering the fluid passing through and from the channel with the filter element.

A method for rejuvenating a lubricating oil by filtration, comprising: introducing a fluid to a filtering apparatus comprising a chemically active filter element, a filter element, and a second filter element; filtering substantially all of the fluid introduced to the filtering apparatus with the chemically active filter element; passing chemically treated fluid into and through a channel defined between the chemically active filter element and the filter element, the channel being configured so as to not limit fluid flow through the chemically active filter element; selectively permitting a first portion of the fluid flowing from the channel to bypass the filter element and to pass through the second filter element; and directing the remaining portion of the fluid flowing from the channel to pass through the filter element.

The above-described and other features and advantages of the present application will be appreciated and understood by those skilled in the art from the following detailed description, drawings, and appended claims.

### BRIEF DESCRIPTION OF DRAWINGS:

FIG. 1 is a cross-sectional view showing an exemplary embodiment of the filtering apparatus of the present invention;

FIG. 2 is a cross-sectional view of an alternative exemplary embodiment of the present invention;

FIG. 3 is a cross-sectional view of another alternative exemplary embodiment of the present invention; and

FIGS. 4A and 4B are a cross sectional views of a portion of exemplary embodiments of the present invention.

### DESCRIPTION OF EXEMPLARY EMBODIMENTS

For purposes of an understanding of the invention, reference will now be made to the apparatus as shown in figures and specific language will be used to describe the same. It will nevertheless be understood that no limitation of the scope of the invention is thereby intended. For instance, throughout the present specification, relative positional terms like ‘upper’, ‘lower’, ‘top’, ‘bottom’, ‘horizontal’, ‘vertical’, and the like are used to refer to the orientation of the filters shown in the drawings. These terms are used in an illustrative sense to describe the depicted embodiments, and are not meant to be limitative. It will be understood that in a specific application thereof, a filter may be installed on an engine in an orientation different from that shown in the drawings, such as inverted 180 degrees or transverse to that shown, and in such a case, the above-identified relative positional terms will no longer be accurate.

Embodiments of the present invention are directed to a system for extending the normal operating life of a fluid circulation system such as an oil circulation system associated with a diesel engine. The system includes an apparatus for assisting in the removal of acids that accumulate in the fluid, such as oil, that is pumped through the circulation system. By removing such acids, the useful life of the circulating fluid may be extended thus lowering the operating costs. For instance, with acid-neutralization as contemplated by the present invention, mileage on a diesel engine used to propel a typical diesel truck may be extended up to a total of 100,000 miles or more between oil changes. This interval is especially important in such systems where the fluid circulation system may contain as much as 50 gallons of oil.

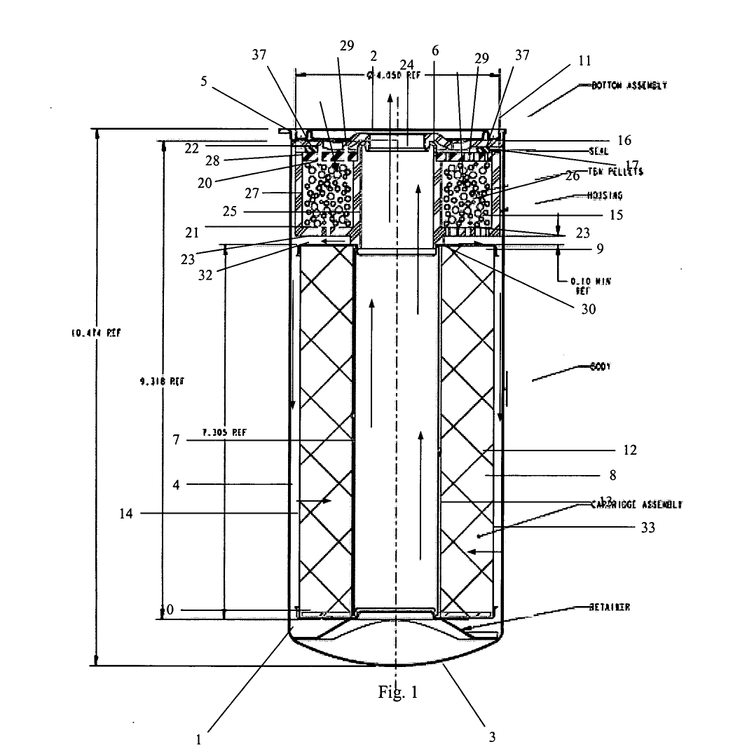

The exemplary embodiments of FIGS. 1-4 include an acid-neutralizing element through which substantially all of the circulating fluid passes. Within the acid-neutralizing element is an acid-neutralizing compound that reacts with the acids in the circulating fluid to neutralize the acids. Once the fluid circulates through the acid-neutralizing compound, the oil passes through a particulate filter included within the system of the invention prior to returning to the oil circulation system. Alternative embodiments contemplate a by-pass valve or by-pass filter for use with the mechanical filter.

FIG. 1 is a cross sectional view of an exemplary embodiment of the filtering and acid-neutralizing apparatus of the present invention. The filtering system may be detachably secured to a block of an internal combustion engine for the filtering of lubricant oil. Preferably, the apparatus of the invention is attached through a spin-on connection. Of course, other methods of securing the oil filter are contemplated to be within the scope of the present invention. The direction of oil flow, through the filter 11, is shown by the arrows in FIG. 1, which illustrate a flow path through the filter.

In an exemplary embodiment, the filtering apparatus comprises a housing 1, preferably in cylindrical form, having an open end 2, a closed end 3, a sidewall 4, and a base plate/seaming lid assembly 5. The housing 1 can be made of any suitable material depending on the intended use of the apparatus. Examples of suitable materials include steel, aluminum, or plastic. Preferably the housing is drawn from relatively heavy gauge steel to include the closed end 3, the open end 2, and the sidewall 4, which is preferably substantially cylindrical. Within the housing 1 is a primary particulate filter 8 and an acid-neutralizing filter element 15. A base plate/seaming lid assembly 5 retains the particulate filter 8 and the acid-neutralizing filter element 15 in the housing 1, wherein a discrete flow path is provided therethrough.

The particulate filter 8 and acid-neutralizing filter element 15 are preferably installed in the housing 1 in stacked relationship, with the particulate filter 8 arranged within the housing 1, the acid-neutralizing filter element 15 stacked on top of the particulate filter 8 in a spaced relationship and adjacent the base plate/seaming lid assembly. The acid-neutralizing filter element 15 and the particulate filter 8 are arranged concentrically around a central tube 7, which as is known in the related arts may be a stainless steel or plastic tube having a plurality of openings therein to provide fluid flow therethrough as well as structural support to the filtration media of the mechanical filter. The housing 1 is seamed to the base plate/seaming assembly 5 to provide a leak proof housing.

Thus, a single body full flow acid-neutralizing fluid filter is provided wherein the acid-neutralizing filter element is disposed above and in a facing spaced relationship with respect to the mechanical filter and all of the items are located within a single housing defining a fluid flow path therethrough.

A base plate 6 of the housing 1 includes a plurality of inlet ports 22 formed therethrough and arranged in a circular pattern. The base plate 6 also includes a central outlet port 24. The outlet port 24 has a plurality of female threads formed therein to allow rotatable mounting of the filter 11 on an externally threaded hollow tubular fitting on an engine block (not shown). An annular external seal or gasket 16 fits engagingly into a groove 17 formed at the bottom surface of the base plate, to resist oil leakage outwardly from the base of the filter.

The particulate filter 8 is composed of a material and designed so as to permit filtering of particulates from the fluid entering the filter. The particulate filter 8 may be formed from any suitable filter media 12 for this purpose. Examples of suitable filter media for the particulate filter 8 include cellulose, synthetic fiber, or micro-glass. In the depicted embodiment of FIGS. 1-3, the particulate filter 8 is a conventional cylindrical member made of accordion-pleated filter paper. Of course, other configurations are contemplated to be within the scope of exemplary embodiments of the present invention.

The particulate filter 8 is constructed in a manner that is well known in the art and is preferably of a typical tubular shape. The particulate filter 8 includes filter media 12 wrapped around an interior foraminous inner support wall 13 in a circular arrangement and in sealing engagement with upper and lower end caps 9 and 10. Alternatively, the filter media is pleated or folded to form a cylindrical item having an inner surface and an exterior surface (e.g., a ring of filtration media without an interior foraminous inner support wall). The exterior dimensions of the exterior surface of the particulate filter is less than the inner diameter or dimensions of the housing so that an inlet annulus 14 is created between the housing 1 and an exterior surface 33 of the particulate filter 8.

The lower end of the particulate filter 8 is sealingly engaged in a ring formed within the interior end of the lower end cap 10. The lower end cap 10 is in the form of a ring into which the bottom ends of the foraminous inner support wall 13 and the particulate filter media 12 fit, and are thus maintained in a spaced concentric relationship within the housing 1.

Upper and lower end openings in the particulate filter provide access to an internal cavity of the filter element. Upper end cap 9 is positioned about the upper end opening and lower end cap 10 is positioned about the lower end opening. Each end cap comprises a sealing ring of material disposed about the corresponding opening. The upper and lower end caps 9 and 10 seal the internal cavity into fluid communication with the central tube 7, which is configured to provide support to the mechanical filter element and also allow fluid flow therethrough.

In operation, oil passes into the particulate filter media 12 through the exterior surface 33 and into the internal cavity, through the foraminous inner support wall 13, and then through the openings in the central tube 7, which abuts the foraminous inner support wall 13 of the particulate filter 8 or alternatively if there is no foraminous inner support wall the inner surface of the filter media of particulate filter 8 and the inner cylindrical dividing wall 25 of the acid-neutralizing filter, and out of the housing 1 through the central outlet port 24.

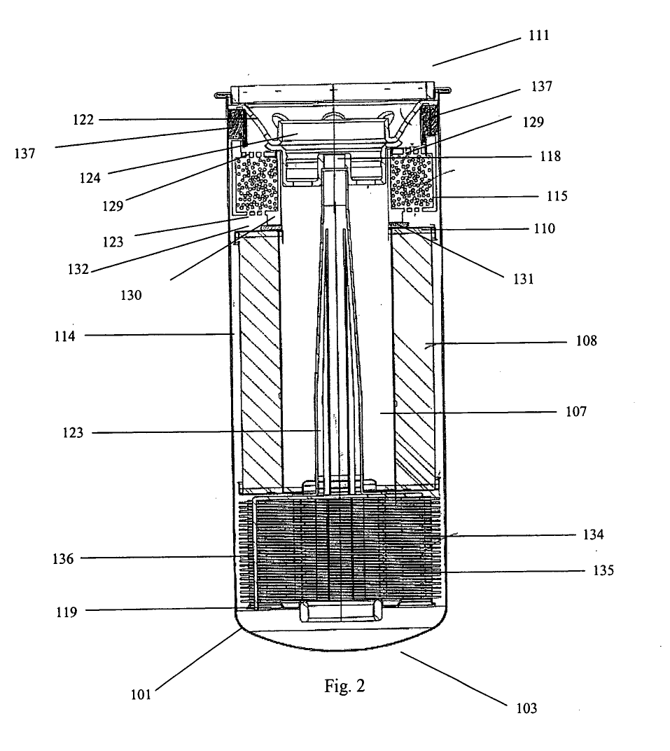

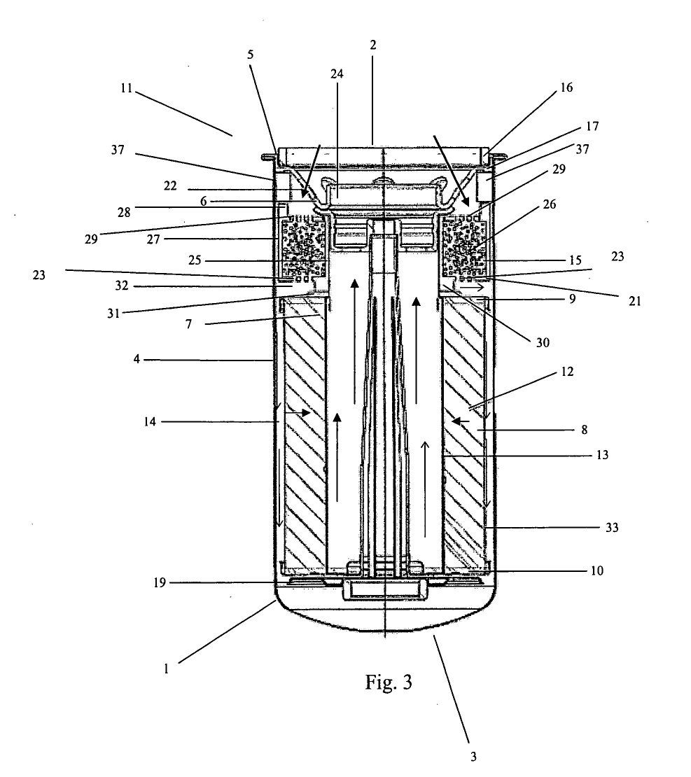

In one alternative construction of the exemplary embodiment depicted in FIG. 1, the filter may include a relief bypass valve built into the closed end 3 of the housing 1 to ensure a supply of oil to lubricate the engine under all conditions (See FIGS. 2 and 3). Under normal operating conditions, the bypass valve is closed. Whenever the filter becomes plugged with contaminants and too restrictive to oil flow, however, the bypass valve will open to draw a portion of the oil from the inlet annulus 14, so that such portion of the oil bypasses the particulate filter 8. Alternatively and as illustrated in FIG. 1, the filter may be constructed without a bypass valve.

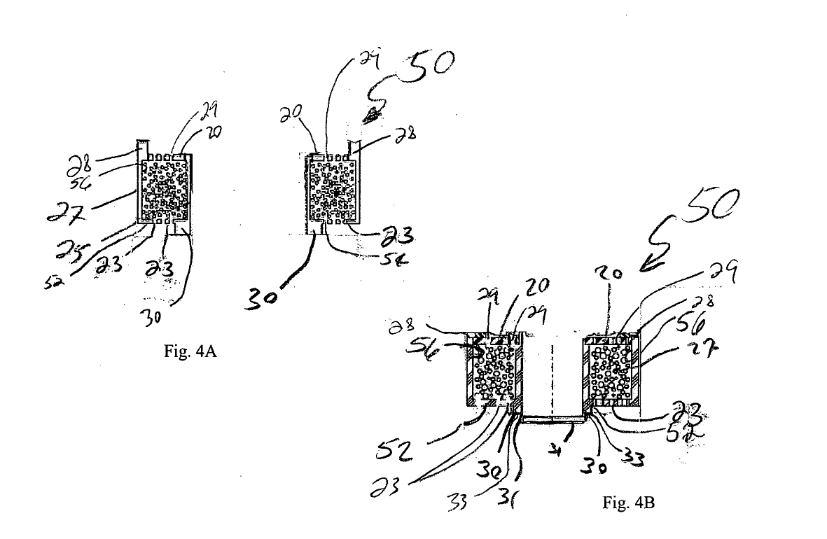

The acid-neutralizing filter element 15 is positioned such that acids found in fluids such as oil passing through the acid-neutralizing compound are neutralized, or such that the TBN associated with the fluid is increased to a desired TBN level. In accordance with an exemplary embodiment, the acid-neutralizing filter element 15 is provided in the shape of a cylinder, and is disposed above the particulate filter 8. Of course, other non-cylindrical configurations of the acid-neutralizing filter element 15 are contemplated to be within the scope of exemplary embodiments of the present invention. Non-limiting configurations are illustrated in FIGS. 4A and 4B. The acid-neutralizing filter element 15 therefore precedes the particulate filter element in the flow path, in order to allow chemical modification of acids or other unwanted contaminants that may be present in the oil, with an acid-neutralizing compound 26 contained within the acid-neutralizing filter element 15, prior to mechanical filtration. This design ensures that all oil entering the filter will pass completely through the acid-neutralizing filter element before it reaches the particulate filter element. Thus, the acid-neutralizing filter element is configured, positioned and dimensioned to receive all inlet oil flow and pass the same through the acid neutralizing compound.

Exemplary embodiments of the present invention relate to an acid-neutralizing filter element 15 having a beneficial neutralizing additive composition incorporated therein as the acid-neutralizing compound 26. The additive composition 26 includes one or more additives which may be selected from the group including basic conditioners, corrosion inhibitors, metal deactivators, antioxidants, dispersants, friction modifiers, oil stabilizers, pour point depressants, detergents, viscosity index improvers, anti-wear agents, extreme pressure additives, mixtures of the above additives, and/or other known beneficial additives.

The basic conditioner, where used, is preferably a basic salt selected from the group consisting of calcium carbonate, potassium carbonate, potassium bicarbonate, aluminum dihydroxy sodium carbonate, magnesium oxide, magnesium carbonate, zinc oxide, sodium bicarbonate, sodium hydroxide, calcium hydroxide, potassium hydroxide, lithium hydroxide and mixtures thereof. In accordance with one non-limiting exemplary embodiment the oil will flow through sodium hydroxide impregnated celite pellets where all the acids will be neutralized by the acid-neutralizing filter element. Thereafter, the treated oil will go through the mechanical filter element.

In one non-limiting example, the additive composition 26 comprises a plurality of sodium hydroxide impregnated celite pellets. In another non-limiting exemplary embodiment, the additive composition is a plurality of sodium hydroxide pellets, wherein the pellets comprise 100% sodium hydroxide. Other embodiments contemplate various ranges of sodium hydroxide (e.g., less than 100%).

Other non-limiting examples of materials comprising the additive composition are those disclosed in the following United States Patents and Patent Publications: U.S. 2004/0058830 A1; U.S. Pat. No. 6,743,759; U.S. 2003/0119682 A1; U.S. Pat. No. 6,774,091; U.S. Pat. No. 6,806,241; and U.S. 2002/0002118 A1; the contents of each of which are incorporated herein by reference thereto.

For example, and as discussed in the aforementioned references the chemically active filter element will comprise a plurality of additive-dispensing modules, each of the additive-dispensing modules having a module housing which is a hollow shell having a plurality of holes formed therein; and an oil additive composition disposed within the module housing, wherein the additive composition comprises at least one additive selected from the group consisting of basic conditioners, crushed limestone, corrosion inhibitors, metal deactivators, antioxidants, dispersants, friction modifiers, oil stabilizers, pour point depressants, detergents, viscosity index improvers, anti-wear agents, extreme pressure additives, and mixtures thereof.

Porous annular upper and lower foraminous dividers 20 and 21, respectively, may be placed above and/or below the acid-neutralizing filter element 15 to retain the acid-neutralizing compound 26 of the acid-neutralizing filter element therebetween while allowing fluid flow therethrough. In other words, the openings of the porous dividers 20 and 21 are smaller than the components of the acid neutralizing compound. For example, if TBN pellets are used the TBN pellets will have a diameter or exterior circumference greater than the openings in the dividers 20 and 21. The dividers 20 and/or 21, where used, may be selectively foraminous solid plates or alternatively may be mesh screens, which are inserted into the housing as a cap (upper or bottom divider) wherein the same is secured to the housing via snap fit, interference fit, welding, adhesives, ultrasonic welding etc. or equivalents thereof in order to ensure the cap is fixedly secured thereto. Depending on the configuration of the housing a single cap or divider may be used only on the top as the bottom portion of the housing will be configured to have openings disposed therein thereby negating the need for a separately inserted cap.

In yet another alternative embodiment, the housing of the acid-neutralizing filter element 15 is formed to have an integral bottom with a plurality of openings again sized smaller than the compounds or pellets of the acid-neutralizing filter element and an upper opening into which the acid-neutralizing compound 26 is disposed and thereafter a foraminous divider is positioned on top of the acid-neutralizing compound 26 to retain the same therein (e.g., a cap (upper divider with openings 23)) is secured to the housing. In essence, the housing of the acid-neutralizing filter element comprises a “U” shaped opening with a porous bottom, wherein the acid-neutralizing compound is inserted therein and a cap with openings is positioned on the top of the housing. FIGS. 4A and 4B illustrate non-limiting examples of such a configuration. In yet another alternative, mesh screens or a foraminous divider is used in conjunction with the openings in the bottom of the acid-neutralizing filter element (e.g., a ring of porous media disposed over larger openings in the bottom wall of the housing of the acid-neutralizing filter element), thus two layers having openings are positioned on the bottom of the housing of the acid-neutralizing filter element. In this embodiment, the second member may provide a filtering function for openings 23 in the bottom of the housing.

The lower foraminous divider or integral bottom 21 has a plurality of apertures 23 extending therethrough while the upper divider 20 has a plurality of apertures 29 extending therethrough. As discussed herein and referring to FIGS. 4A and 4B and in at least one embodiment, the housing of the acid-neutralizing filter element has an integral bottom with a plurality of openings extending therethrough. In one exemplary embodiment, apertures 23 are disposed around a portion of the annulus of the bottom of the housing. In another exemplary embodiment, apertures 23 are disposed around a substantial portion of the annulus of the bottom of the housing.

The bottom of the housing is constructed and arranged to pass oil only to a flow channel or gap 32 that is defined by the cylindrical space below the lower foraminous divider or bottom wall of the acid-neutralizing filter element 15 and above upper end cap 9 of the particulate filter 8 in the flow path defined by the housing 1. In accordance with an exemplary embodiment, the flow channel or gap 32 is large enough to facilitate a flow distribution within the filter 11 that does not limit fluid flow through the acid-neutralizing filter element 15 and is adequate to allow the filter to deliver a steady and adequate supply of decontaminated and purified oil to the engine. In accordance with an exemplary embodiment, the width of the gap between the lower foraminous divider of the acid-neutralizing filter element and the upper end cap of the particulate filter is approximately 0.10 inches. Of course, the dimension of gap 32 may be greater or less than 0.10 inches as long as full flow through the acid-neutralizing filter element is provided.

In accordance with an exemplary embodiment the oil filter is a medium duty oil filter and “full flow” is defined as approximately 15-20 gallons of fluid flow therethrough per minute. In other words, the housing of the acid-neutralizing filter element, inlet openings, outlet openings and gap 32 are configured to ensure all flow through is through the acid-neutralizing filter element without providing a restriction on the fluid flow. In another exemplary embodiment, the oil filter is a heavy-duty oil filter and full flow is defined as approximately 15-30 gallons fluid flow therethough per minute. Of course, and as applications may require “full flow” may defined by flow rates that are greater or less than the aforementioned ranges.

In operation, fluid flows from the acid-neutralizing filter element 15 through openings 23 and into the flow channel 32. The fluid then passes horizontally through the flow channel as end cap 9 as well as end cap 10 provide a fluid barrier. Thereafter, the fluid flows into the inlet annulus 14 disposed about the periphery of the particulate filter. The fluid then flows through the particulate filter 8, exiting through the particulate filter's foraminous downstream side 13 into the central tube 7.

In one exemplary embodiment and referring now to FIGS. 1-4, the acid-neutralizing filter element 15 comprises a housing 50 formed from an easily molded material such as plastic. The housing has inner and outer cylindrical dividing walls 25, 27 integrally formed therewith. In one exemplary embodiment, a bottom 52 extends from inner dividing wall 25 to outer dividing wall 27. In this embodiment, bottom 52 defines the lower divider and has a plurality of openings 23 extending therethrough. Thus, no separate lower foraminous divider is provided. In accordance with an exemplary embodiment housing 50 is configured to have a “U” shape wherein an upper opening 56 is provided to receive the acid neutralizing compound therein. In other words, the bottom and side walls of housing 50 define a receiving area for receipt of the acid neutralizing compound therein. Of course, other configurations are considered to be within the scope of exemplary embodiments of the present invention. Thereafter, an upper divider with openings is inserted into the housing (e.g., a cap with openings is inserted therein).

In one exemplary embodiment, the inner cylindrical dividing wall 25 prevents oil that has passed through and exited the particulate filter from entering the acid-neutralizing filter element 15 as it exits the filter through the central tube 7. Alternatively, inner cylindrical dividing wall 25 is disposed about central tube 7, which extends all the way to the base plate/lid assembly and the portion of the central tube disposed within the acid-neutralizing filter element does not have any openings therein.

In another alternative exemplary embodiment, the chemically active filter element will further comprise a plurality of flow distribution inserts positioned to evenly distribute the fluid across the acid-neutralizing compound located in the housing of the chemically active filter element.

In yet another alternative exemplary embodiment, the housing of the chemically active filter element will comprise integral upper and lower walls with openings formed therein and the housing is molded about the acid-neutralizing compound. Thus, this embodiment would not require either the upper or lower dividers as they will be molded into the housing with openings and the housing will be molded about the acid-neutralizing compound.

In order to dispose lower portion or bottom 52 in a spaced relationship with respect to upper end cap 9 in order to define flow path 32, an inner transverse horizontal flange 30 extends from the base of the inner cylindrical dividing wall 25, wherein a dimension of the flange determines the height of the channel between the acid-neutralizing filter element and the cap of the mechanical filter. Inner transverse horizontal flange 30 also prevents oil that has exited from the acid-neutralizing filter element through the openings in the bottom of the housing positioned between walls 25 and 27 into the flow channel 32 from mixing with oil that is exiting the filter through the central tube 7. Alternatively, inner transverse horizontal flange 30 is disposed about central tube 7, which extends all the way to the base plate/lid assembly and the portion of the central tube disposed within the acid-neutralizing filter element does not have any openings therein.

As illustrated in FIG. 4B and when the central tube 7 does not extend all the way to the base plate/lid assembly, inner transverse horizontal flange 30 is configured to have a flange or locating flange 31 and shoulder portion 33 for positioning of the housing on top of the mechanical filter element. In essence, flange 31 is positioned to be received within the inner diameter of the central tube and shoulder portion 33 is positioned on top of the central tube and the cap of the mechanical filter wherein the dimensions of flange 30 define a height of flow channel 32. Alternatively, and referring now to FIG. 2 the flange rests on top of a gasket positioned on top of the central tube and the cap of the mechanical filter.

In accordance with an exemplary embodiment, the housing and the outer cylindrical dividing wall 27 prevent oil that has entered the housing through the inlet ports 22 from bypassing the acid-neutralizing filter element 15. An outer transverse horizontal flange 28 extends from the top of the outer cylindrical dividing wall 27 and is met on its top surface by a contiguous cylindrical rubber seal 37 to ensure that no oil will bypass the acid-neutralizing filter element 15 in the flow path before it reaches the particulate filter element 8. Alternatively, rubber seal 37 is an O-ring disposed within an inner diameter defined by flange 28. Accordingly, all inlet oil flow must pass through the acid-neutralizing filter element 15.

FIG. 2 is a cross sectional view of another exemplary embodiment of the filtering and acid-neutralizing apparatus of the present invention. Here items performing similar or analogous functions to the embodiment of FIG. 1 are labeled in multiples of 100. This exemplary embodiment of the invention includes all of the features of the filtering apparatus depicted in FIG. 1, and is further configured to include a bypass filtration structure 134 disposed within and adjacent to the base of the filter housing 101 to ensure a supply of oil to lubricate the engine under all conditions. In this exemplary embodiment, a flat circular gasket 131 is used to seal the space between the inner transverse horizontal flange 130 and the upper end cap 109 of the particulate filter 108.

In general, the oil filter of this exemplary embodiment comprises a housing 101, an acid-neutralizing element 115, a primary particulate filter 108, and a bypass filtration structure 134. The bypass filtration structure 134 is disposed downstream of the primary particulate filter 108 in the flow path defined by the housing 101.

A relief bypass valve 119 is built into the closed end 103 of the housing 101. Under normal operating conditions, the bypass valve 119 is closed. Whenever the filter becomes plugged with contaminants and too restrictive to oil flow or the pressure in the oil filter exceeds a predetermined level, the bypass valve 119 will open to draw a portion of the oil from the inlet annulus 114. The configuration ensures that bypass oil flow, before exiting the housing 101, will be filtered by a secondary particulate filter 135, which in an exemplary embodiment is less restrictive than filter 108.

The components are arranged such that in normal operation, oil entering the housing 101 flows in the same path as in the exemplary embodiment depicted in FIG. 1. Thus, oil flowing through the filter 111 enters through the housing inlet ports 122, flows through the a acid-neutralizing element 115 first, then flows into and through the flow channel 132, and then through the primary particulate filter 108 before leaving the housing 101 through outlet port 124.

Should the pressure differential across the primary particulate filter 108 exceed a selected value, the bypass filtration structure 134 functions to selectively allow bypass flow around (that is, not through) the primary particulate filter 108 by opening the bypass valve 119. In accordance with an exemplary embodiment and as is known in the related arts bypass valve 119 comprises a spring biased member configured to open when a predetermined pressure is encountered. During operation of the bypass valve 119, a portion of the oil flowing through the filter, after passing though the flow channel 132, circumvents the primary filter element 108 and is directed through the bypass filtration structure 134.

The bypass filtration structure 134 functions to direct the bypass oil in a selected path that extends into an intermediate flow region 136 positioned below the primary particulate filter 108 and ensures the bypass oil is at least filtered by a secondary particulate filter 135 and then passed through a central stand pipe 123 before leaving the housing 101 through outlet port 124.

Both the fluid flowing through the particulate filter 108 and the fluid passing through the bypass valve 119 into the central stand pipe 123 will flow to and mix in the downstream end 118 of the central tube 107 and ultimately out of the filter and back to the fluid circulation system such as an oil system for a diesel engine.

FIG. 3 illustrates yet another alternative configuration wherein only a bypass valve 19 is provided (e.g., a bypass valve without a bypass filter).

In the manner explained by the above descriptions of the exemplary embodiments, an acid-neutralizing filter effectively neutralizes acids in the filtered fluid, a particulate filter effectively removes impurities from the filtered fluid, and a flow path facilitates a flow distribution within a filter that is adequate to allow the filter to deliver a steady and adequate supply of decontaminated and purified oil to an engine. The present invention, however, is not limited to the features explained above; rather, many modifications and alternations can be conceived by those skilled in the art within the scope of the invention. For instance, the particulate and acid-neutralizing filters may be formed in various manners and of various materials as mentioned above. In addition, while they are preferably located within a single housing, they may be contained within separate but interconnected shells.

For example, although the above descriptions of exemplary embodiments of the present invention indicates that a particulate filter and an acid-neutralizing filter element are installed in the housing in stacked relationship and arranged concentrically around a central tube, any shape, structure, and/or arrangement for the filtration system can be used that is able to pass used oil entering the filter through both a chemically active filter element and a mechanically active filter element sequentially, wherein substantially all of the oil entering the system passes through the chemically active filter element. Furthermore, any shape, structure, and/or arrangement for the filtration system can be used that is able to provide, for such a filtration system, a flow path design that does not limit fluid flow through the chemically active filter element. Other non-limiting examples of filtration systems and arrangements are those disclosed in the following United States Patents and Patent Publications: U.S. Pat. No. 6,379,564 B1; U.S. 2002/0014447 A1; U.S. 2003/0111398 A1; U.S. 2005/0040092 A1; U.S. Pat. No. 6,623,636 B2; and U.S. 2004/0154970 A1, the contents of each of which are incorporated herein by reference thereto, are considered to be related to the present invention and can be also be used. It should be appreciated that the location of the filter elements in a filtration system and the design of the system are not critical, and generally can be any of those known for fluid filtration systems that incorporate a mechanically active filter element and a chemically active filter element.

All of the references cited herein, including patents, patent applications, and publications, are hereby incorporated in their entirety by reference. The use of the terms “a” and “an” and “the” and similar referents (e.g., “a base plate” or “the bypass valve”) in the context of describing the present invention (especially in the context of the following claims) should be construed to cover both the singular and the plural, unless otherwise indicated herein or clearly contradicted by context.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims and their legal equivalence.

What is claimed is:

1. An oil filter, comprising:
a housing having an inlet and an outlet and defining a fluid flow path between the inlet and outlet through a chamber therein;
a filter element disposed inside the housing in the flow path, the filter element comprising a body of filter media having an exterior surface and an interior surface and a first end opening and a second end opening each providing access to an internal cavity of the filter element, wherein fluid is filtered by passing through the inlet, through the exterior surface into the cavity and through the outlet;
a first end cap positioned about the first end opening, wherein the first end cap comprises a sealing ring of material disposed about the first opening and a second end cap positioned about the second end opening, wherein the second end cap comprises a sealing ring of material disposed about the second opening, the first end cap and the second end cap sealing the cavity into fluid communication with the outlet; and
a chemically active filter element having inlet openings and outlet openings, the chemically active filter element being disposed inside the housing and configured to receive substantially all fluid flowing into the housing through the housing inlet.

2. The oil filter as in claim 1, wherein the chemically active filter element is disposed in a facing spaced relationship with respect to the first end cap to define a channel between the first end cap and the outlet openings, wherein the channel does not limit fluid flow through the chemically active filter element.

3. The oil filter as in claim 2, wherein the channel between the first end cap and the outlet openings has a height of at least 0.10 inches.

4. The oil filter as in claim 2, wherein the chemically active filter element comprises a chemically active filter housing having inner and outer cylindrical dividing walls integrally formed with a bottom that extends from the inner dividing wall to the outer dividing wall, wherein the bottom has a plurality of openings extending therethrough.

5. The oil filter as in claim 4, wherein the chemically active filter housing is configured to have a substantially “U” shape wherein an upper opening is provided to receive an acid neutralizing compound therein.

6. The oil filter as in claim 5, wherein the chemically active filter housing further comprises a flange extending from a base of the inner dividing wall towards the first end cap, the flange defining a height of the channel.

7. The oil filter as in claim 5, wherein the chemically active filter housing further comprises an acid-neutralizing compound disposed therein and a foraminous divider positioned in the upper opening after the acid-neutralizing compound is disposed therein.

8. The oil filter as in claim 7, wherein the acid-neutralizing compound comprises an additive composition comprising at least one additive selected from the group consisting of basic conditioners, crushed limestone, corrosion inhibitors, metal deactivators, antioxidants, dispersants, friction modifiers, oil stabilizers, pour point depressants, detergents, viscosity index improvers, anti-wear agents, extreme pressure additives, and mixtures thereof.

9. The oil filter as in claim 7, wherein the acid-neutralizing compound comprises a basic salt selected from the group consisting of calcium carbonate, potassium carbonate, aluminum dihydroxy sodium carbonate, magnesium carbonate, zinc oxide, sodium bicarbonate, sodium hydroxide, calcium hydroxide, potassium hydroxide, lithium hydroxide and mixtures thereof.

10. The oil filter as in claim 7, wherein the acid-neutralizing compound is a plurality of sodium hydroxide impregnated celite pellets.

11. The oil filter as in claim 7, wherein the acid-neutralizing compound is a plurality of sodium hydroxide pellets, wherein the pellets comprise 100% sodium hydroxide.

12. The oil filter as in claim 6, wherein the chemically active filter housing further comprises a locating flange extending from the flange, wherein the locating flange is configured to be received within an inner diameter the filter element.

13. The oil filter as in claim 6, wherein a gasket is disposed between the flange and the fist end cap of the filter element.

14. The oil filter as in claim 6, wherein the chemically active filter housing further comprises an outer flange that extends from a top of the outer cylindrical dividing wall, wherein the outer flange is met on its top surface by a contiguous cylindrical rubber seal to ensure that fluid will bypass the chemically active filter.

15. An oil filter, comprising:
a housing having an inlet and an outlet and defining a fluid flow path between the inlet and outlet through a chamber therein;
a filter element disposed inside the housing in the flow path, the filter element comprising a body of filter media having an exterior surface and an interior surface and a first end opening and a second end opening each providing access to an internal cavity of the filter element, wherein fluid is filtered by passing through the inlet, through the exterior surface into the cavity and through the outlet;
a first end cap positioned about the first end opening, wherein the first end cap comprises a sealing ring of material disposed about the first opening and a second end cap positioned about the second end opening, wherein the second end cap comprises a sealing ring of material disposed about the second opening, the first end cap and the second end cap sealing the cavity into fluid communication with the outlet; and
a chemically active filter element having inlet openings and outlet openings, the chemically active filter element being disposed inside the housing and in a facing spaced relationship with respect to the first end cap to define a channel between the first end cap and the outlet openings, wherein the channel does not limit fluid flow through the chemically active filter element.

16. The oil filter as in claim 15, wherein the chemically active filter element is configured to receive substantially all fluid flowing into the housing through the housing inlet and wherein the filter element and the chemically active filter element are positioned concentrically around a substantially cylindrical central passageway and the chemically active filter element comprises an acid-neutralizing compound.

17. The oil filter as in claim 16, wherein the chemically active filter element further comprises a plurality of additive-dispensing modules, each of the additive-dispensing modules comprising:
a module housing which is a hollow shell having a plurality of holes formed therein; and
an oil additive composition disposed within the module housing, wherein the additive composition comprises at least one additive selected from the group consisting of basic conditioners, crushed limestone, corrosion inhibitors, metal deactivators, antioxidants, dispersants, friction modifiers, oil stabilizers, pour point depressants, detergents, viscosity index improvers, anti-wear agents, extreme pressure additives, and mixtures thereof.

18. The oil filter as in claim 16, wherein the oil filter is a medium duty oil filter and operates to filter approximately 15-20 gallons of fluid per minute.

19. The oil filter as in claim 16, wherein the oil filter is a heavy-duty oil filter and operates to filter approximately 15-30 gallons of fluid per minute.

20. The oil filter as in claim 16, wherein the oil filter further comprises a bypass valve for controlling the flow of fluid through the flow path.

21. The oil filter as in claim 16, wherein the oil filter further comprises a second filter element adjacent to the base of the housing, wherein a first portion of the fluid flowing through the filter may be selectively permitted to bypass the filter element and pass through the second filter element, with the remaining portion of the fluid flowing through the filter directed to pass through the filter element.

22. A method for rejuvenating lubricating oil by filtration, comprising:
introducing a fluid to a filtering apparatus comprising a chemically active filter element and a filter element;
filtering substantially all of the fluid introduced to the filtering apparatus with the chemically active filter element;
passing chemically treated fluid into and through a channel defined between the chemically active filter element and the filter element, the channel being configured so as to not limit fluid flow through the chemically active filter element; and
filtering the fluid passing through and from the channel with the filter element.

23. A method for rejuvenating a lubricating oil by filtration, comprising:
introducing a fluid to a filtering apparatus comprising a chemically active filter element, a filter element, and a second filter element;
filtering substantially all of the fluid introduced to the filtering apparatus with the chemically active filter element;
passing chemically treated fluid into and through a channel defined between the chemically active filter element and the filter element, the channel being configured so as to not limit fluid flow through the chemically active filter element;
selectively permitting a first portion of the fluid flowing from the channel to bypass the filter element and to pass through the second filter element; and
directing the remaining portion of the fluid flowing from the channel to pass through the filter element.
